(19) United States
(12) Patent Application Publication
(10) Pub. No.: US 2023/0399008 A1
(43) Pub. Date: Dec. 14, 2023

(54) MULTISTATIC RADAR POINT CLOUD FORMATION USING A SENSOR WAVEFORM ENCODING SCHEMA

(71) Applicant: GM Cruise Holdings LLC, SAN FRANCISCO, CA (US)

(72) Inventor: Daniel Flores Tapia, Fairfield, CA (US)

(21) Appl. No.: 17/836,013

(22) Filed: Jun. 9, 2022

(51) Int. Cl. B60W 60/00; H04W 4/46

(52) U.S. Cl. CPC B60W 60/001; H04W 4/46; B60W 2420/52; B60W 2554/4041

(57) ABSTRACT

Methods and apparatus disclosed within provide a solution to problems associated with objects located in a blind spot of a radar apparatus of a first vehicle. An identifier included a set of received radar signals may be extracted from the received radar signals to identify a radar device of a second vehicle. Information may then be received that identifies a location of the second vehicle. This received information may also include operational characteristics of the received radar signals. Evaluations may then be performed on the received radar signals using the received information such that a location of an object located in the blind spot of the radar apparatus may be identified. Data associated with the object may then be stored in a set of radar detection data that that also includes locations of other objects that were detected by direct observations made by the radar apparatus of the first vehicle.

### BACKGROUND

### 1. Technical Field

The present disclosure is generally related to improving radio detection and ranging (radar) devices. More specifically, the present disclosure is directed to radar devices in automotive applications.

### 2. Introduction

Autonomous vehicles (AVs) are vehicles having computers and control systems that perform driving and navigation tasks that are conventionally performed by a human driver.

As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors, and radar elements disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example of a system for managing one or more Autonomous Vehicles (AVs) in accordance with some aspects of the present technology.

FIG. 2 illustrates a series of steps that may be performed at a sensing apparatus of an automated vehicle (AV).

FIG. 3 includes a series of steps that may be performed as part of the preprocessing steps or additional processing steps discussed in respect to FIG. 2 when data of a point cloud are populated or expanded.

FIG. 4 illustrates an example of one radar device that receives reflected radars signals that were transmitted from another radar device.

FIG. 5 shows an example of a computing system that may be used to implement at least some of the functions reviewed in the present disclosure in accordance with some aspects of the present technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of different radar signals from different vehicles to improve overall operation of a sensing apparatus. The present disclosure contemplates that in some instances, this gathered data may include personal information. The present disclosure contemplates that the entities involved with such personal information respect and value privacy policies and practices.

Methods and apparatus disclosed within provide a solution to problems associated with objects located in a blind spot of a radar apparatus of a first vehicle. An identifier included a set of received radar signals may be extracted from the received radar signals to identify a radar device of a second vehicle. This identifier may be extracted from the received radar signals such that information may then be received that identifies a location of the second vehicle. This received information may also include operational characteristics of the received radar signals and this information may be received based on communications with a centralized computing device and/or based on vehicle to vehicle (V2V) communications with controller of the second vehicle. Evaluations may then be performed on the received radar signals using the received information such that a location of an object located in the blind spot of the radar apparatus may be identified. Data associated with the object may then be stored in a set of radar detection data that that also includes locations of other objects that were detected by direct observations made by the radar apparatus of the first vehicle. The locations of these other objects may have been identified after the radar apparatus transmitted its own radar signals and received reflections of those same radar signals.

Since the set of radar detection data may include data associated with detections made directly by a processor of the radar apparatus and may include data associated with detections based on radar signals transmitted by other radar devices, objects located in the vicinity of the radar apparatus may be identified even when they are located within a bind spot of the radar apparatus. This set of radar detection data may then be made available to other processes, such as processes that track the movement of objects around an automated vehicle (AV). Methods and apparatus of the present disclosure, may therefore, identify locations of objects that are blocked from a field of view of the radar apparatus and objects that are within the field of view of the radar apparatus. Different correlation functions may be performed that allow the apparatus to identify objects and to identify object velocities using different sets of program code instructions. These different evaluations and correlations may result in the generation of a set of “point-cloud” information that may be used by other processes of a sensing apparatus.

Radar sensors, such as those used in autonomous vehicle (AV) applications commonly support different operating modes that are tailored to specific operating environments. In certain instances, a number of autonomous vehicles (AVs) may be located within a proximity of each other where radar devices at each respective AV receive radar signals from other vehicles. Methods and apparatus of the present disclosure may be configured to communicate with devices at other vehicles such that radar signals received from those vehicles can be analyzed. Such analysis may be used to identify objects that are located in a blind spot of a radar apparatus of a first vehicle. Methods of the present disclosure may receive a radar signal that was originally transmitted from a radar apparatus of a second vehicle after that radar signal bounced off an object located in a blind spot of a radar apparats of the first vehicle. These methods may include a computer sending requests for data to a computer of a nearby vehicle after which the computer of the nearby vehicle may send data back to the computer that sent the request. The data sent back to the computer may identify parameters of radar waveforms currently being used by a radar apparatus of the nearby vehicle and possibly information that identifies a location of the nearby vehicle. Such location information may have been identified based on a global positioning system (GPS) of the nearby vehicle. In such instances, location resolution may be increased using a form of assisted GPS. Various forms of assisted GPS may be used. For example, radio signals from cell tower or other transmitters may be combined with received GPS data to identify a location. A radar apparatus of a first vehicle may transmit a radar signal, receive reflected radar signals that were reflected off an object located at a received GPS location. The radar apparatus of the first vehicle may then identify that the object located at the GPS location is the second vehicle. This means that the radar apparatus of the first vehicle may use its own radar data to improve the accuracy of the location of the second vehicle.

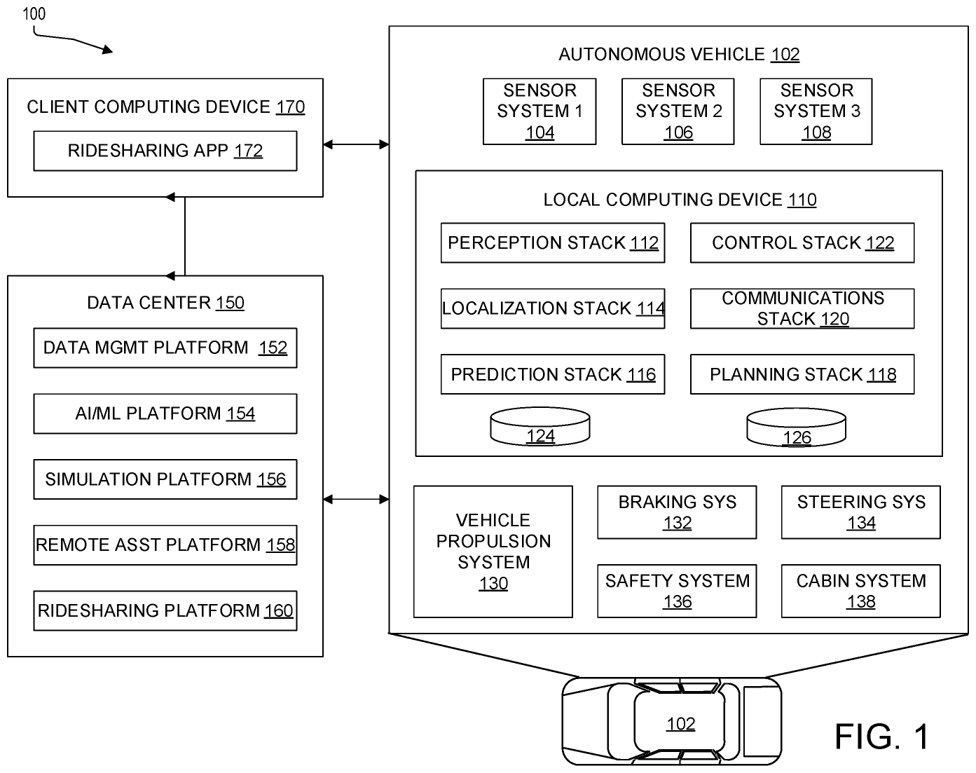

FIG. 1 illustrates an example of a system for managing one or more Autonomous Vehicles (AVs) in accordance with some aspects of the present technology. FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity.

Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

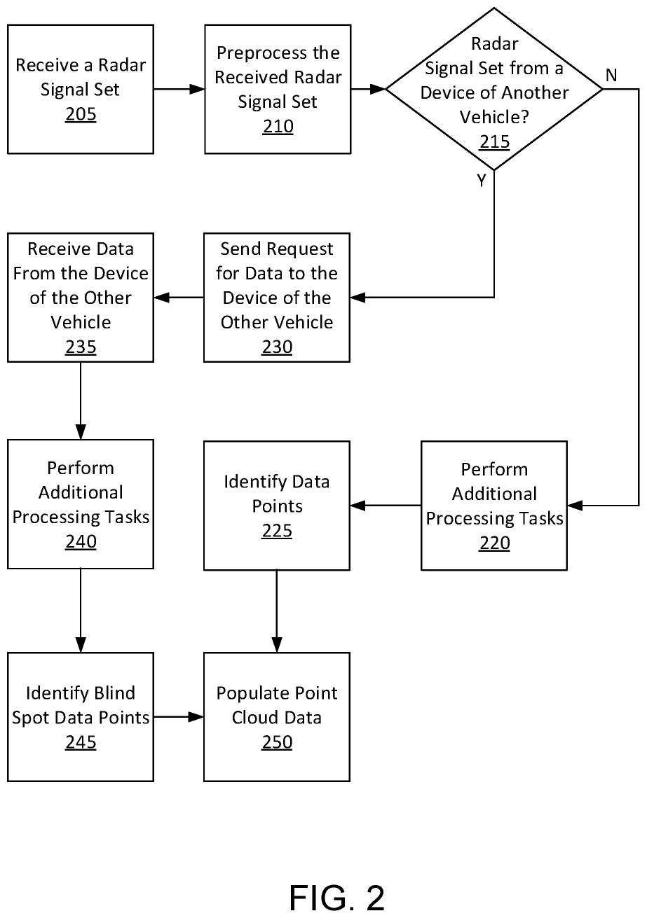

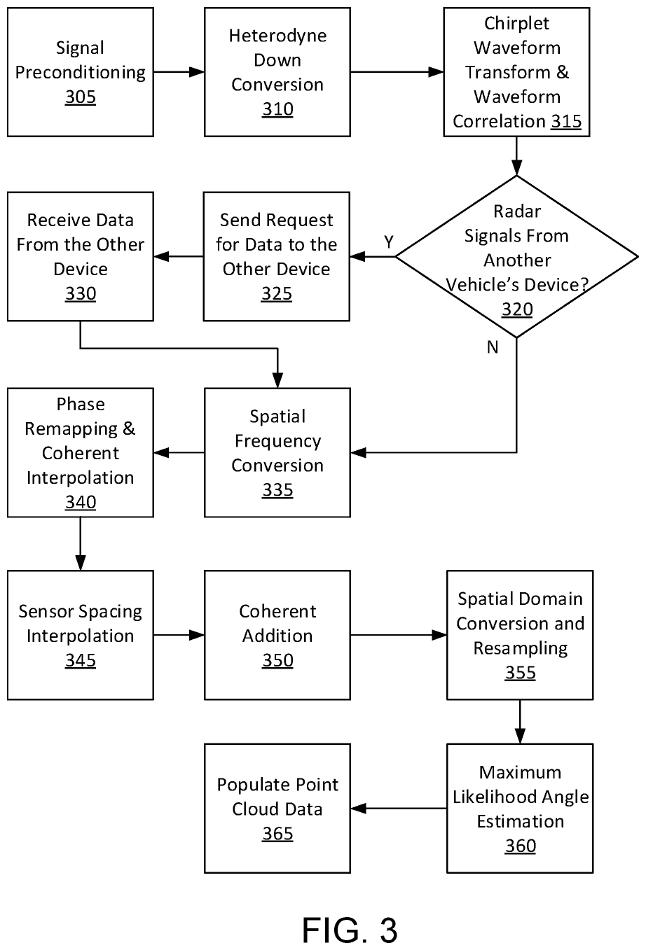

FIG. 2 illustrates a series of steps that may be performed at a sensing apparatus of an automated vehicle (AV). The steps of FIG. 2 may be performed by a processor executing instructions out of a memory at the sensing apparatus of the AV. A set of radar signals may be received by a radar apparatus of a first vehicle in step 205 and those radar signals may be preprocessed in step 210 of FIG. 3. The preprocessing in step 210 may include conditioning or filtering the received radar signals.

The set of received radar signals may include encoded information that identifies a particular radar apparatus that transmitted the set of radar signals. This identifier may be used to identify the particular radar apparatus that transmitted the radar signal. In certain instances, such received radar signals may have been transmitted by the same radar apparatus that transmitted the received radar signals (e.g. the radar apparatus of the first vehicle). Here the radar apparatus of a first vehicle may transmit a radar signal that is then reflected off an object back to the radar apparatus of the first vehicle.

In other instances, the received radar signal may have been transmitted by a radar apparatus of a second vehicle. The preprocessing performed in step 210 may also include extracting a device identifier from the received set of radar signals. Determination step 215 may then identify whether the received radar signal belongs to the radar apparatus of the first vehicle or a radar apparatus of another vehicle. When determination step 215 identifies that the received set of radar signals were received from a radar apparatus of another vehicle, program flow may move to step 230 of FIG. 2. Alternatively, when the set of received radar signals do not belong to another vehicle, program flow may move to step 220 of FIG. 2.

Steps 220 and 225 may be steps that are consistent with normal operations of a radar apparatus. Step 220 may perform processing tasks from which data points may be identified in step 225 of FIG. 2. The data points identified in step 225 may be associated with an object detected by the radar apparatus and these data points may be associated with a location of the detected object. After step 225 a set of data referred to as “point cloud” data may be populated with the data point data identified in step 250 of FIG. 2.

Data included in a point cloud may include data from multiple time steps and radar antennas or apparatuses. This point cloud data may identify places around a sensing apparatus from which radar reflections were received. Locations of data points of combined data may be identified and used to extract per-point features from external sources (for example, a-priori semantic maps containing road surface type labels).

Point cloud data may be organized in a way that is amenable to application of a machine learned algorithm. For example, the data may be organized into a matrix where rows of the matrix may correspond to respective data points and columns of the matrix correspond to raw radar features (like approximate RCS or range rate) for each data point. This feature data may include hand engineered features, radar domain-knowledge features, or a combination of both. For a given detected point, point cloud data may include radiometric features like radar cross section as well as doppler features such as an ambiguous range rate or velocity. The data included in this matrix may be data from point clouds of multiple physical radars and multiple temporal frames that have been aggregated and projected into a feature space using domain-specific preprocessing and feature extraction. This point cloud data may include data associated with target or object data extracted in steps 220 and 225 or relative velocities of various objects may be identified in these steps.

Once the data has been populated in the point cloud in step 250, that data may be provided to other sub-systems or be accessed by other processes of a radar apparatus when other functions of the radar apparatus are performed. For example, the data may be provided to a process that makes perceptions about objects associated with the point cloud data. The point cloud data may be used to identify movement vectors or to identify whether an object is a risk of being impacted by an autonomous vehicle (AV) where the radar apparatus resides.

Step 230 of FIG. 2 may send a request for data to a radar device or computer associated with another vehicle after which data may be received from this other vehicle in step 235. Communications performed in steps 230 and 235 may be performed using a form of vehicle to vehicle (V2V) communications using any known communication technology. The data received in step 235 may identify a frequency, magnitude, phase, chirp rate, a frequency change rate, a duration (transmission time) of a transmitted radar signal set, and/or information that identifies a location of the other vehicle. As such, the data received in step 235 may identify a location of this other vehicle as well as characteristics of radar signals currently being used by the radar device of this other vehicle. A processor of the radar apparatus of the first vehicle may perform evaluations based on the characteristics of the radar signals received in step 235. These evaluations may be used to identify location and or motion vectors to associated with a location of an object in the field of view of the radar device of the other vehicle while that object is located in a blind spot of the radar apparatus of the first vehicle.

In certain instances, a computing device or sensing apparatus of an AV may also send and receive data to a centralized computer accessible via a communication network (e.g. a cellular network). For example, AVs that belong to a fleet of vehicles may received information identifying other vehicles of that fleet of vehicles that are located at a nearby location. This could include devices of each of a set of vehicles transmitting GPS or other location information and device identifying information to the centralized computer. The centralized computer could then transmit information to the set of vehicles based on where respective vehicles are located. A first device of a first vehicle may be sent information identifying identifiers that can be used to identify a particular radar apparatus by decoding information in a set of received radar signals. The data sent to respective vehicle devices may identify a current location of vehicles that are near the first vehicle. The information received from the centralized computer may also be used by a computer or sensing apparatus of a vehicle such that V2V communications can be established between the vehicles. Alternatively, the communications performed in steps 230 and 235 may only be implemented using V2V communications. These V2V communications may be implemented using transmitted and received via radio devices at respective vehicles using a standard communication protocol or a proprietary communication protocol.

Next in step 240 additional processing tasks may be performed. The processing tasks performed in step 240 may be similar to the processing tasks performed in step 220 of FIG. 2. Here the processing tasks may evaluate radar signal data and location data of a nearby vehicle to identify detections (i.e. reflections of radar signals) that are included in a blind spot of a sensing apparatus of a first vehicle in step 245 of FIG. 2. This processing may then identify data points associated with these blind spot detections. These blind spot detections may then be added to the point cloud data in step 250 of FIG. 2.

FIG. 3 includes a series of steps that may be performed as part of the preprocessing steps or additional processing steps discussed in respect to FIG. 2 when data of a point cloud are populated or expanded. FIG. 3 includes step 305 where received radar signals are preconditioned or filtered to eliminate the system effects. Next in step 310 a heterodyne down conversion needs to be performed. The actions performed in step 310 may include providing a known constant frequency and radar signals that include components of that known constant frequency into circuitry that generates a reduced frequency signal that does not include the components of the known constant frequency. This process may be similar to the processing of radio signals that include amplitude or frequency modulated signals and audio signals. Here, instead of outputting audio, the heterodyne down conversion may output a baseband signal that includes encoded radar responses data.

After step 310 step 315 may implement a chirplet transform and a waveform correlation function. Here a chirplet may be a windowed portion of a chirp function that may be associated with a window that provides a time localization property. “This chirplet transformation may represent a rotated, sheared, or other transformation associated with a time-frequency plane. Next, determination step 320 may identify whether received signals are from a device of another vehicle. Determination step 320 may then identify whether the received radar signals were sent from a radar device of another vehicle, when no program flow may move to step 335. When determination step 320 identifies that the received radar signals are from another device, program flow may move to step 325 where a request for data is sent to the radar device or computer of the other vehicle after which data may be received from the radar device or computer of the other vehicle in step 330. Steps 320, 325, and 330 may perform actions similar to the actions described in respect to steps 215, 230 and 235 of FIG. 2.

After step 330, program flow may move to step 335. Steps 335, 340, 345, 350, 355, and 360 may be steps that are performed either when processing radar signals that belong to a radar apparatus of a vehicle that originally transmitted those radar signals or when processing signals that belong to a radar apparatus of another vehicle. Steps 335, 340, 345, 350, 355, and 360 may perform operations similar to the action discussed in respect to the processing of additional tasks and identifying points to include in a set of radar point cloud data discussed in respect to steps 220 & 225 or steps 240 & 245 of FIG. 2.

A processor executing instructions out of a memory may perform a spatial frequency conversion in step 335. This may include performing a fast Fourier transform (FFT) on the received radar data to convert data in the frequency domain to data in the time domain. Next in step 340, phase remapping and coherent interpolation functions may be performed. Since a radar device may include multiple antennas, the radar device may combine data received by different antenna receiving elements in a way that compensates for differences in particular received radar signals being received by different antenna elements at slightly different points in time. The processor of the radar device may then identify offsets that may be associated with the radar device using multiple antenna. In an instance when a radar device includes three antenna elements, a first radar element may transmit a radar signal that bounces off a vehicle and then the reflected radar signal may be received by the first radar element, a second radar element, and a third radar element at different times. Since, each of these different elements received the reflected radar signal at different times (for example, based on a spatial distance between the respective radar elements), step 345 may associate these different detections with a same object at a same point in time, instead of being associated with one or more objects and/or the different times.

After step 345, the processor may coherently add different radar signal pulses. This may include measuring both the phase and amplitude of each received radar pulse. Step 355 is a step where the processor may perform a spatial domain and resampling process after which angles may be estimated in step 360. After step 360, data may be added to a set of point cloud data in step 365 of FIG. 3. The various processing steps in FIG. 3 may be used to associate data points with a grid around a vehicle.

Data included in a point cloud may include data from multiple time steps and radar antennas or apparatuses. This point cloud data may identify places around a sensing apparatus from which radar reflections were received. Locations of data points of combined data may be identified and used to extract per-point features from external sources (for example, a-priori semantic maps containing road surface type labels).

Point cloud data may be organized in a way that is amenable to application of a machine learned algorithm. For example, the data may be organized into a matrix where rows of the matrix may correspond to respective data points and columns of the matrix correspond to raw radar features (like approximate RCS or range rate) for each data point. This feature data may include band engineered features, radar domain-knowledge features, or a combination of both. For a given detected point, point cloud data may include radiometric features like radar cross section as well as doppler features such as an ambiguous range rate or velocity. The data included in this matrix may be data from point clouds of multiple physical radars and multiple temporal frames that have been aggregated and projected into a feature space using domain-specific preprocessing and feature extraction. This point cloud data may include data associated with target or object data or the velocities of objects.

Once the data has been populated in the point cloud, that data may be provided to other sub-systems or be accessed by other processes of a radar apparatus when other functions of the radar apparatus are performed. For example, the data may be provided to a process that makes perceptions about objects associated with the point cloud data. The point cloud data may be used to identify movement vectors or to identify whether an object is a risk of being impacted by an autonomous vehicle (AV) where the radar apparatus resides.

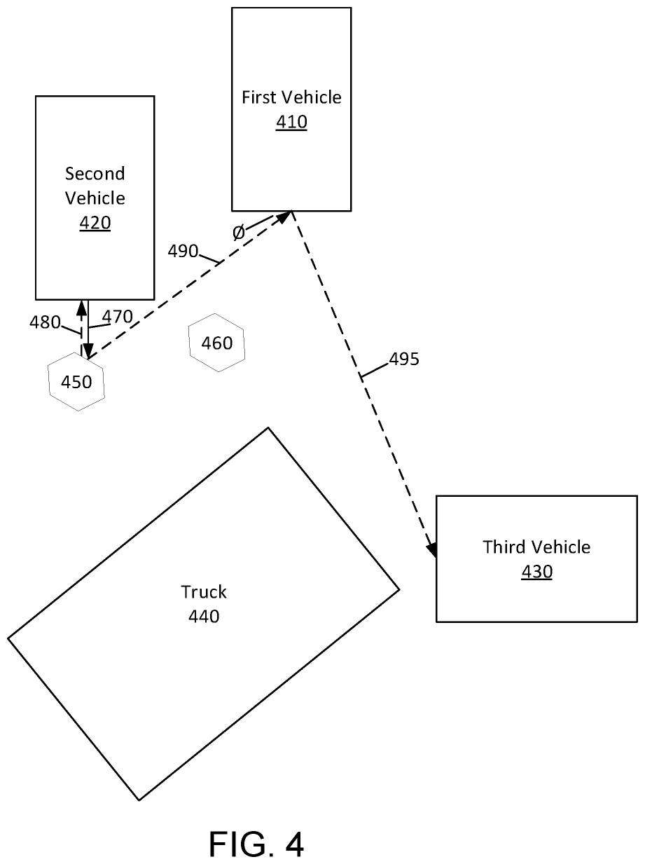

FIG. 4 illustrates an example of one radar device that receives reflected radars signals that were transmitted from another radar device. FIG. 4 includes a first vehicle 410, a second vehicle 420, and a third vehicle 430. Each of the first, second, and third vehicles (items 410, 420, & 430 of FIG. 4) may include their own respective radar apparatus. FIG. 4 also includes truck 440 and objects 450 & 460. Objects 450 & 460 may be pedestrians in a crosswalk at a time when the first vehicle 410 and the second vehicle 420 are stopped. Truck 440 may be turning to its left and truck 440 may be followed by the third vehicle 430. Item 470 is a radar signal transmitted from a radar apparatus at the second vehicle 420. Items 480, 490, & 495 are reflected radar signals. After radar signal 470 is transmitted, radar signal 480 is reflected off object 450 directly back to the second vehicle 420. A portion of the radar signal energy 490 reflected off object 450 is reflected to a radar apparatus of the first vehicle 410. Some of the energy of the reflected radar signal 490 may then be reflected off the first vehicle 410. This is represented as radar signal 495. Radar signal 495 includes radar signal energy that reflected off both object 460 and the first vehicle 410.

Note that because of the locations of item 460 and truck 440, radar signals transmitted from a radar apparatus of the first vehicle 410 may not be transmitted back to the radar apparatus of the first vehicle 410. This means that item 450 is in a bind spot of the radar apparatus of the first vehicle 410. As discussed in respect to the flow chart of FIG. 2, the radar apparatus of the first vehicle 410 may send a request and then receive data associated with that request. Here again, this received data may identify a frequency, magnitude, phase, chirp rate, a frequency change rate, a duration (transmission time) of a transmitted radar signal set, and/or data that identifies a location of the second vehicle 420.

Vehicle location data, and data related to the frequency, phase, chirp rate, frequency change rate, and/or transmitted signal energy may be used to identify items within the field of view of a radar apparatus of second vehicle may be used to identify objects that are in a blind spot of a particular radar apparatus. Calculations performed when analyzing radar signal data associated with another radar apparatus may identify where a second vehicle is located relative to a location of a first vehicle. Radar signals from a second radar device received at a first radar device may be received after those signals have been reflected off an object or may be received without reflecting off an object. Signal processing may identify an angle to associate with an object a received radar signal from another radar device in a manner that is similar to identifying an angle associated with an object detected by a transmission of radar signals from a radar device of the vehicle that transmitted the radar signals. Based on a location of a second vehicle, a radar apparatus of a first vehicle may identify a transmission pathway by which a radar signal passed through space by identifying vectors that correspond to radar signals 470 and 490.

A radar apparatus of the first vehicle 410 may identify the angle associated with a reflected radar signal 490 and may identify the location of a second vehicle. A processor of a first radar apparatus may identify a location where the radar signal was emitted from second radar device based on the information identifying where a second vehicle is located. This angle Ø is an angle associated with reflected radar signal 490, object 450, and the first vehicle 410. The processor of the first radar apparatus may identify a likely pathway that radar signal 470 moved from the second radar apparats of the second vehicle 420. An intersection of vectors associated with radar signal 470 and reflected radar signal 490 may be identified and from this information, a location of object 450 may then be identified at a point where these two vectors intersect. This data may be stored at the first radar apparatus as part of a set of point cloud data even when an object associated with that data is located in a blind from of the first radar apparatus.

When a radar apparatus of a third vehicle 430 of FIG. 4 receives radar signal 495, that apparatus may also receive location information associated with the first vehicle 410 and the second vehicle 420. This third radar apparatus may perform evaluations that could be used to identify an approximate location of object 450 using vector equations. Here again a likely transmission pathway of radar signal 470 may be identified, an angle associated with reflected radar signal 495 may be identified. A radar apparatus of the third vehicle 430 may transmit radar signals that reflect off first vehicle 410, item 460, and truck 440. The radar apparatus of the third vehicle 430 may not be able to directly perceive the second vehicle 420 and item 450 because they are located in a blind spot of the third vehicle's 430 radar apparatus. Based on receipt of reflected radar signal 495, received location information (identifying the location of the second vehicle 420) may allow the radar apparatus of the third vehicle to estimate a location of item 450 being within a blind spot zone located between the front of the second vehicle 420, and between truck 440 and item 460 of FIG. 4. As truck 440 continues making a left turn, the radar apparatus of the third vehicle 430 would then be in a position to directly observe the location of item 450. The foreknowledge that some item was located in this blind spot could help a controller of an autonomous vehicle (AV) 430 to “watch out” for or avoid object 450. This controller could limit the speed of the third vehicle 430 until a determination of a precise location of object 450 has been identified.

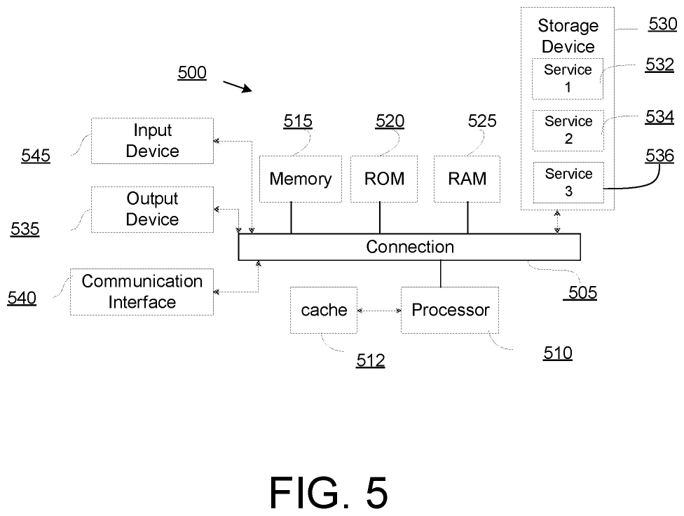

FIG. 5 shows an example of computing system 500 that may be used to implement at least some of the functions reviewed in the present disclosure. In certain instances, a computing device may be incorporated into a sensing apparatus or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 542, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc.

Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

1. A method for processing radar data by an apparatus of a first vehicle, the method comprising:
extracting an identifier of a radar device from a received radar signal set;
associating the received radar signal set with a radar detection, wherein the radar detection is an object within a field of view of the radar device when the object is located in a blind spot of the apparatus of the first vehicle;
identifying that the radar device identifier is associated with a second vehicle;
receiving information that includes a location of the second vehicle; and
performing an evaluation that identifies a location of the radar detection when the object is within the field of view of the radar device and when the object is located in the blind spot of the first vehicle.

2. The method of claim 1, further comprising extracting characteristics of the radar device of the second vehicle from the received information, wherein the location of the radar detection is based at least in part on the characteristics of the radar device.

3. The method of claim 2, wherein the characteristics of the radar device include at least one of a frequency, a magnitude, a phase, a chirp rate, a frequency change rate, or a duration time of the received radar signal set.

4. The method of claim 1, further comprising establishing vehicle to vehicle (V2V) communications via a communication device of the second vehicle, wherein the received information is received via the V2V communications.

5. The method of claim 1, further comprising:
identifying a first vector to associate with the received signal set and the radar detection; and
identifying a second vector to associate with the second vehicle and the detection, wherein the location of the radar detection is associated with a point where the first vector intersects the second vector.

6. The method of claim 1, further comprising storing a data point in association with information that identifies the location of the radar detection as part of a set of radar detection data, wherein the set of radar detection data also includes data points associated with radar signals transmitted and received by the apparatus of the first vehicle.

7. The method of claim 1, further comprising transmitting information for receipt by an apparatus of another vehicle, the transmitted information identifying a location of the first vehicle.

8. The method of claim 7, wherein the transmitted information also includes one or more characteristics of the apparatus of the first vehicle.

9. A computing system for processing radar data, the system comprising:
at least one non-transitory computer readable medium comprising instructions stored thereon, wherein the instructions are effective to cause the computing system to:
extract an identifier of a radar device from a received radar signal set;
associate the received radar signal set with a radar detection, wherein the radar detection is an object within a field of view of the radar device when the object is located in a blind spot of the apparatus of the first vehicle;
identify that the radar device identifier is associated with a second vehicle;
receive information that includes a location of the second vehicle; and
perform an evaluation that identifies a location of the radar detection when the object is within the field of view of the radar device and when the object is located in the blind spot of the first vehicle.

10. The computing system of claim 9, wherein the instructions are effective to further cause the computing system to extract characteristics of the radar device of the second vehicle from the received information, wherein the location of the radar detection is based at least in part on the characteristics of the radar device.

11. The computing system of claim 10, wherein the characteristics of the radar device include at least one of a frequency, a magnitude, a phase, a chirp rate, a frequency change rate, or a duration time of the received radar signal set.

12. The computing system of claim 9, wherein the instructions are effective to further cause the computing system to establish vehicle to vehicle (V2V) communications via a communication device of the second vehicle, wherein the received information is received via the V2V communications.

13. The computing system of claim 9, wherein the instructions are effective to further cause the computing system to:
identify a first vector to associate with the received signal set and the radar detection; and
identify a second vector to associate with the second vehicle and the detection, wherein the location of the radar detection is associated with a point where the first vector intersects the second vector.

14. The computing system of claim 9, wherein the instructions are effective to further cause the computing system to store a data point in association with information that identifies the location of the radar detection as part of a set of radar detection data, wherein the set of radar detection data also includes data points associated with radar signals transmitted and received by the apparatus of the first vehicle.

15. The computing system of claim 9, wherein the instructions are effective to further cause the computing system to transmit information for receipt by an apparatus of another vehicle, the transmitted information identifying a location of the first vehicle.

16. The computing of claim 15, wherein the transmitted information also includes one or more characteristics of the apparatus of the first vehicle.

17. A non-transitory computer readable medium comprising instructions stored thereon, wherein the instructions are effective to cause the computing system to:
extract an identifier of a radar device from a received radar signal set;
associate the received radar signal set with a radar detection, wherein the radar detection is an object within a field of view of the radar device when the object is located in a blind spot of the apparatus of the first vehicle;
identify that the radar device identifier is associated with a second vehicle;
receive information that includes a location of the second vehicle; and
perform an evaluation that identifies a location of the radar detection when the object is within the field of view of the radar device and when the object is located in the blind spot of the first vehicle.

18. The non-transitory computer-readable medium of claim 17, wherein the instructions are effective to further cause the computing system to extract characteristics of the radar device of the second vehicle from the received information, wherein the location of the radar detection is based at least in part on the characteristics of the radar device.

19. The computing system of claim 18, wherein the characteristics of the radar device include at least one of a frequency, a magnitude, a phase, a chirp rate, a frequency change rate, or a duration time of the received radar signal set.

20. The non-transitory computer-readable medium of claim 17, wherein the instructions are effective to further cause the computing system to establish vehicle to vehicle (V2V) communications via a communication device of the second vehicle, wherein the received information is received via the V2V communications.
